(19) United States
(12) Patent Application Publication
(10) Pub. No.: US 2006/0011366 A1
(43) Pub. Date: Jan. 19, 2006

(54) INLET VALVE FOR PNEUMATIC TOOL

(75) Inventor: Chi-Shen Liao, Da Li City (TW)

Correspondence Address: NIKOLAI & MERSEREAU, P.A., 900 SECOND AVENUE SOUTH, SUITE 820, MINNEAPOLIS, MN, 55402, US

(73) Assignee: MIGHTY SEVEN INTERNATIONAL CO., LTD., Wu-Jih Shiang (TW)

(21) Appl. No.: 11/160,209

(22) Filed: Jun. 14, 2005

(30) Foreign Application Priority Data
Jul. 19, 2004 (TW) 93211382

(51) Int. Cl. B23B 45/04

(52) U.S. Cl. 173/169

(57) ABSTRACT

An inlet valve is provided for a pneumatic tool. The pneumatic tool defines a space and a passageway communicated with the space. The inlet valve includes a ring and a controller. The ring can be tilted in the space between a first position where it blocks the space from the passageway and a second position where it allows the communication between the space and the passageway. The ring defines a central aperture. The controller can be pivoted in the space between a first position, a second position and a third position. The controller includes a disc and a rod raised from the disc. The disc is put against the ring as the controller is in the first position and pivoted from the ring as the controller is in the second position. The rod is inserted through the central aperture of the ring. The diameter of the rod is smaller than that of the central aperture of the ring in order to allow pressurized air to travel through the central aperture of the ring as the controller is in the second position. The rod pivots the ring to the second position as the controller is in the third position.

### BACKGROUND OF INVENTION

1. Field of Invention

The present invention relates to a pneumatic tool and, more particularly, to an inlet valve for a pneumatic tool.

2. Related Prior Art

Pneumatic tools are convenient and efficient tools for drilling and driving screws.

In Taiwanese Patent Publication 567954, for example, is disclosed an inlet valve for a pneumatic tool. The pneumatic tool includes a pistol-shaped body 200. The inlet valve includes a ring 20 put in the body 200, a housing 30 connected to the ring 20, a ball 40 put in the housing 30, an sealing washer 50 put between the housing 30 and the ball 40, and a C-ring 60 put in the housing 30 for restraining the ball 40 in the housing 30. The housing 30 defines a space 35 and an aperture 36 communicated with the space 35. The ball 40 is put in the space 35. An end of a rod 91 can be inserted in the space 35 through the aperture 36. An opposite end of the rod 91 can be pushed by means of a trigger 10 installed on the body 200. Normally, the ball 40 rests against the sealing washer 50 and blocks the aperture 36. When the trigger 10 is pulled, the ball 40 is pushed from the sealing washer 50 due to the rod 90 put between the trigger 10 and the ball 40. However, the use of the pneumatic tool with this conventional inlet valve is not convenient in some cases. An example is made of an operation where the pneumatic tool is used to drive nuts for fastening a wheel to a vehicle. At first, the nuts are loosely engaged with bolts that carry the wheel. Only after all of the nuts are loosely engaged with bolts is the engagement tightened. This operation requires some personal skills to operate the pneumatic tool in a two-step manner. This operation is troublesome.

The present invention is therefore intended to obviate or at least alleviate the problems encountered in prior art.

### SUMMARY OF INVENTION

According to the present invention, an inlet valve is provided for a pneumatic tool. The pneumatic tool defines a space and a passageway communicated with the space. The inlet valve includes a ring and a controller. The ring can be tilted in the space between a first position where it blocks the space from the passageway and a second position where it allows the communication between the space and the passageway. The ring defines a central aperture. The controller can be pivoted in the space between a first position, a second position and a third position. The controller includes a disc and a rod raised from the disc. The disc is put against the ring as the controller is in the first position and pivoted from the ring as the controller is in the second position. The rod is inserted through the central aperture of the ring. The diameter of the rod is smaller than that of the central aperture of the ring in order to allow pressurized air to travel through the central aperture of the ring as the controller is in the second position. The rod pivots the ring to the second position as the controller is in the third position.

The primary advantage of the pneumatic tool equipped with the inlet valve according to the present invention is the two-step operation.

Other advantages and novel features of the invention will become more apparent from the following detailed description in conjunction with the drawings.

### BRIEF DESCRIPTION OF DRAWINGS

The present invention will be described through detailed illustration of the preferred embodiment referring to the drawings.

FIG. 1 is a cross-sectional view of a pneumatic tool with an inlet valve according to the preferred embodiment of the present invention.

FIG. 2 is an exploded view of the inlet valve shown in FIG. 1.

FIG. 3 is a cross-sectional view of the inlet valve shown in FIG. 1 at a first step of operation.

FIG. 4 is a cross-sectional view of the inlet valve shown in FIG. 1 at a second step of operation.

### DETAILED DESCRIPTION OF PREFERRED EMBODIMENT

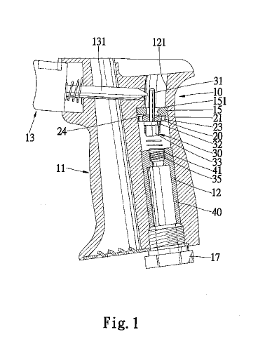

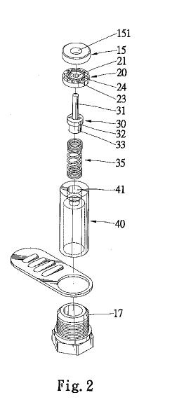

Referring to FIGS. 1 and 2, a pneumatic tool 10 is equipped with an inlet valve according to the preferred embodiment of the present invention. The pneumatic tool 10 includes a pistol-shaped body that is only shown partially. The pistol-shaped body includes a barrel (not shown), a handle 11 extended from the barrel, and a trigger 13 put on the handle 11. The handle 11 defines a space 12 and a passageway 121 communicated with the space 12. Pressurized air can travel through the space 12 and the passageway 121. The inlet valve is put in the space 12 in order to control the travel of the pressurized air.

The inlet valve includes a washer 15, a ring 20, a controller 30, and a spring 35. The washer 15 is put in the space 12 against an annular shoulder (not numbered) formed between the space 12 and the passageway 121. The washer 15 defines an aperture 151.

The ring 20 is put in the space 12 against the washer 15. The ring 20 includes a central aperture 21 defined therein, several peripheral apertures 23 defined therein, and an annular ridge 24 formed thereon between the central aperture 21 and the peripheral apertures 23. The annular ring 24 of the ring 20 is put against the washer 15. The central aperture 21 of the ring 20 is communicated with the aperture 151 of the washer 15.

The controller 30 includes a block 33, an enlarged disc 32 formed on the block 33 and a rod 31 formed on the disc 32. The rod 31 is inserted through the central aperture 21 of the ring 20 and the aperture 151 of the washer 15. The diameter of the rod 31 is smaller than that of the central aperture 21 of the ring 20 so that the pressurized gas can travel between the rod 31 and the ring 20.

An end of the spring 35 is put around the block 33. An opposite end of the spring 35 is put in a recess 41 defined in a tube 40. The spring 35 is compressed between the disc 32 and the tube 40. Because of the spring 35, the disc 32 is pressed against the ring 20.

A hollow restraint 17 is put in the space 12 in order to restrain the inlet valve in the space 12. A thread formed on the hollow restraint 17 is engaged with a thread formed on the wall of the space 12.

The trigger 13 includes a reduced end 131 in contact with the rod 31.

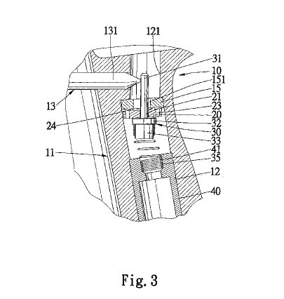

Referring to FIG. 3, a first step of the operation of the inlet valve will be described. At the first step, the trigger 13 is slightly pushed. The reduced end 131 of the trigger 13 pushes the rod 31 slightly. Thus, the disc 32 is tilted slightly. A gap occurs between the ring 20 and the disc 32. The pressurized air travels to passageway 121 from the space 12 through the gap between the disc 32 and the ring 20 and through the central aperture 21. The annular ridge 24 is still in sealing contact with washer 15.

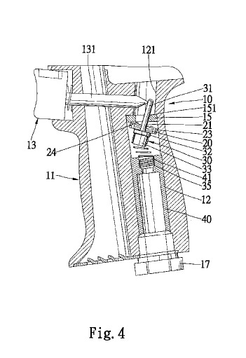

Referring to FIG. 4, a second step of the operation of the inlet valve will be described. At the second step, the trigger 13 is further pushed than at the first step. The reduced end 131 of the trigger 13 further pushes the rod 31. Thus, the disc 32 is further tilted. The gap between the ring 20 and the disc 32 becomes bigger. In addition, the ring 20 is tilted. The pressurized air travels to the passageway 121 from the space 12 through the peripheral apertures 23 and through the aperture 151. The pressurized air travels through the pneumatic tool 10 at a higher rate at the second step than at the first step.

Advantages of the pneumatic tool equipped with the inlet valve of the present invention will be discussed in an exemplary operation where it is used to drive nuts for fastening a wheel to a vehicle. At first, the nuts are loosely engaged with bolts on which the wheel is installed. Only after all of the nuts are engaged with the bolts loosely is the engagement tightened. Thus, the wheel is attached to the vehicle adequately. To this end, a user operates the trigger to a first extent in order to actuate the inlet valve to the first step. At this instant, the user can only engage the nuts with the bolts loosely no matter how long he or she operates the trigger. Then, the user operates the trigger to a second extent in order to actuate the inlet valve to the second step. At this instant, the user can tighten the engagement of the nuts with the bolts. With the pneumatic tool equipped with the inlet valve of the present invention, the user can attach the wheel to the vehicle adequately without skills.

Those skilled in the art can derive variations from the preferred embodiment without departing from the scope of the present invention. Therefore, the preferred embodiment shall not limit the scope of the present invention defined in the claims.

What is claimed is:

1. An inlet valve for a pneumatic tool, the pneumatic tool defines a space and a passageway communicated with the space, the inlet valve comprising:
a ring that can be tilted in the space between a first position where it blocks the space from the passageway and a second position where it allows the communication between the space and the passageway, the ring defining a central aperture; and
a controller for pivotal in the space between a first position, a second position and a third position, the controller comprising:
a disc put against the ring as the controller is in the first position and pivoted from the ring as the controller is in the second position; and
a rod raised from the disc and inserted through the central aperture of the ring, the diameter of the rod being smaller than that of the central aperture of the ring in order to allow pressurized air to travel through the central aperture of the ring as the controller is in the second position, the rod pivoting the ring to the second position as the controller is in the third position.

2. The inlet valve according to claim 1 comprising a spring connected between the controller and the wall of the space in order to keep the controller in the first position.

3. The inlet valve according to claim 2 wherein the controller comprises a block formed on the disc opposite to the rod and fit in an end of the spring.

4. The inlet valve according to claim 3 comprising a tube put in the space, the tube defining a recess for receiving an opposite end of the spring.

5. The inlet valve according to claim 1 comprising a washer put in the space for sealing contact with the ring in the first position, the washer defines an aperture through which the rod is inserted and through which the pressurized air can travel.

6. The inlet valve according to claim 1 wherein the ring comprises:
a plurality of peripheral apertures through which the pressurized air can travel; and
an annular ridge formed between the central aperture and the peripheral apertures for blocking the space from the peripheral apertures as the ring is in the first position.

7. The inlet valve according to claim 1 comprising an annular seal put on the annular flange for blocking the outlet.

8. The inlet valve according to claim 1 wherein the rod is in contact with a trigger so that the trigger is operable in order to pivot the rod to the third position from the first position through the second position.
